(19) United States
(12) Patent Application Publication
(10) Pub. No.: US 2003/0188938 A1
(43) Pub. Date: Oct. 9, 2003

(54) Self -guided locking device for a motorcycle disk brake piece

(76) Inventor: Chiyuan Li, Taipet Shien Taiwan (CN)

Correspondence Address: WORKMAN NYDEGGER & SEELEY, 1000 EAGLE GATE TOWER, 60 EAST SOUTH TEMPLE, SALT LAKE CITY, UT, 84111, US

(21) Appl. No.: 10/148,166

(22) PCT Filed: Apr. 6, 2001
(86) PCT No.: PCT/CN01/00546

(30) Foreign Application Priority Data
May 26, 2000 (CN) 00236869.2
Feb. 22, 2001 (CN) 01219586.2

(51) Int. Cl. F16D 69/00

(52) U.S. Cl. 188/265

(57) ABSTRACT

A self-guided locking device for a motorcycle disk brake piece includes a lock body provided with an insertion slot to receive a motorcycle disk brake piece. A locking bolt and a locking location pin are disposed in the lock body. The locking bolt and the locking location pin can be forced by a spring to extend to the insertion slot. When the motorcycle disk brake piece inserts into the insertion slot. The locking location pin first comes into contact with the motorcycle disk brake piece to release the locking bolt. The blocking bolt is forced by a spring to penetrate through a hole of the motorcycle disk brake piece so as to seal off the insertion slot.

### FIELD OF THE INVENTION

The present invention relates to a locking device, and more particularly to a self-guided locking device for motorcycle disk brake.

### BACKGROUND OF THE INVENTION

In general, a motorcycle disk brake lock is mounted on a wheel axle of the motorcycle for operatively clipping the disk brake by means of a clip to disable the axle from rotating for brake purposes, wherein a plurality of through holes are arranged on the disk brake according to the need of a practical design to enhance the effects functioned by the disk, such as heat radiating, anti-deforming, etc. A locking device for use in locking disk brake is now available on the market, which is adapted exteriorly, taking advantage of the structural feature of the through holes over the disk, to incapacitate a motor cycle by inserting a lock bolt inside the locking device in a through hole of the disk brake to fix the locking device with respect to the disk brake such that the disk brake is prevented from rotating.

However, in order to fix a locking device with respect to a disk brake firmly, the lock bolt must be of a suitable diameter to ensure the structure strength to certain extent, with very small allowance existing between the lock bolt and the through hole. Accordingly, when a locking function is to be implemented, a motor cyclist has to tune the key many times, until the lock bolt has approached to and pressed on the surface of the disk brake and keep moving the locking device gradually until he has perceived that the lock bolt aligns with the through hole, and then totally rotate the key for making the lock bolt pass through the through hole and locking the motor cycle. Due to the lower position of the disk brake and the practical limited parking space, it is impossible for the motor cyclists to squat down or bend over to rotate the key holding the locking device with both hands, resulting in an extent of inconvenience by practice.

### SUMMARY OF THE INVENTION

It is the primary objective of the present invention to provide a self-guided locking device for motorcycle disk brake for a more convenient and quicker activation to lock the disk brake.

It is another objective of the present invention to provide a self-guided locking device for motorcycle disk brake, which is, in addition to more convenient in using, more suitable to limited parking space.

To achieve above objectives of the present invention, the technological solution is taught by a self-guided locking device for motorcycle disk brake, which comprises:

a lock body, defining the main body for assembling of the lock as a whole and having an insert slot formed thereon to receive the disk brake;

a lock sleeve, provided in the lock body and controllable through a key to lock or unlock the disk brake;

a lock bolt, provided in the lock body and forced into the slot by an effort supplied by and elastic member; and

a locating bolt, an end of which is urged against an elastic reset member into the insert slot;

wherein upon putting the disk brake into the insert slot, the lock bolt enters into the insert slot urged by the elastic reset member, as result of that the locating bolt, poked by the disk brake, sets the lock bolt free from the confinement thereon, and the lock bolt, in turn, is urged against the disk brake, and the lock body and the lock bolt are moved to align witha through hole on the disk brake, such that the lock bolt enters into the through hole to incapacitate the motorcycle disk brake.

Two intercepted parallel columned holes may be formed above the insert slot on the lock body for housing the lock sleeve and the lock bolt respectively, and a rotatable body is engaged on the lower end of the lock sleeve to bring interaction to the lock sleeve and lock bolt. A through hole is centered in the rotatable body and a tubing hole is formed at the bottom of said through hole. In a columned hole of the lock body a protruded seat which can be engaged with the tubing hole of the rotatable body is formed at the bottom thereof, allowing the rotatable body to be positioned on the seat through the tubing hole and the lock sleeve to be seated in the through hole by the end of a lock core, and a pair of ears are formed on the top surface of said rotatable body, with a pole provided laterally on the lock core for operatively poking the ears. The lock bolt, structured as a shaft, covered by an end cap, is housed within the columned hole and contacts the insert slot through a guiding hole situated on the bottom of the columned hole, and a guiding pole formed on the top of the lock bolt can be inserted directly into a guiding hole on the bottom of the end cap. Also a compression spring is engaged on the guiding pole of the lock bolt to urge against the lock bolt so that the lock bolt is applied with a force to insert the lock bolt into the insert slot automatically. A protruded block is formed in the middle of the lock bolt and a slanted guiding edge is formed on the outer surface thereof to drive the rotatable body of the lock bolt, such that the lock bolt is engaged with a slanted guiding edge by means of the protruded block. A locating bolt is provided between the rotatable body and the insert slot.

The locating bolt shaped as a plate having a push-poking surface formed at the bottom thereof engages in a guiding slot which is formed on the center of the protruded seat below the rotatable body. A pair of ears are formed on both sides on the top of the locating bolt, on the top of the ears a notch recess is formed to confine a compression spring. Urged by the compression spring, an end of the locating bolt is inserted in the insert slot, and the locating bolt is prevented from falling down by a stop functioned by the lateral ears on both sides of the locating bolt. In the tubing holt at the bottom of the rotatable body, a torsional spring is provided, which enables the rotatable body rotating automatically in a predetermined direction to urge the lock bolt insert into the insert slot. Meanwhile, an inner ring may be formed in the middle of a through hole of the rotatable body, a pair of notches are formed on the inner ring in the direction towards the locating bolt, such that the ears of the locating bolt can be passed through the inner ring or located just at the notch of the inner ring, and so serve as a confinement preventing the rotatable body from following an elastic reset member.

A flange may be formed at the outer top edge of the lock sleeve, an end cap to depress the lock bolt may be formed adjacent the lock sleeve to form a concave arc for engaging a convex edge of the lock sleeve. Such that a depression is acted on the end cap by the lock sleeve. The lock sleeve can be fixed on the lock body by a fix pin to complete the assembling of the lock sleeve, the lock bolts and the end cap.

Three intercepted parallel columned holes may be formed above the insert slot on the lock body housed in one of the columned holes by an end cap. Some protruding points may be formed on the lower end of the lock core. The lower end of the lock sleeve is provided with a rotatable body. The bottom of the lock core is inserted in the tubing hole formed on the bottom of the rotable body and some protruded particles are engaged exactly with the protruded points. A torsional spring is provided between the lock sleeve and the rotatable body. A slant slot and an inverted-L guiding slot are provided on the opposite side walls of the rotatable body respectively. The lock bolt and the locating bolt, both shaped as shafts, are situated in the other two columned holes on the opposite sides of the rotatable body respectively, and on the sides of the lock bolt and the locating bolt protruded shafts are formed which correspond to the slant slot and the guiding slot respectively, between the top ends of the lock bolt and the locating bolt and the top cap a compress spring is provided which allows to be inserted into the insert slot via a guiding hole at the bottom of the columned hole; a poking surface is formed on the bottom of the locating bolt. The protruded shaft of the locating bolt is located at the vertical section of the inverted guiding slot and the protruded shaft of the lock bolt and exerts a confinement on the rotatable body from rotation.

An ear with small holes may be formed at one side of the lock sleeve, and a few small holes may be also formed on the top periphery of the rotatable body, so that the two ends of the torsional spring can be inserted into the holes on the lock sleeve and the rotatable body respectively.

Four locating holes are formed on the top surface of said lock body. By engaging the four locating bar formed on the lower bottom of the top cap with the four locating holes the top cap covers the lock body to complete assembling the lock sleeve, lock bolt and locating bolt.

According to the present invention, by means of that, a locating bolt adaptable to confine the movement of the rotatable body is provided between the insert slot and the rotatable body which drives the lock bolt into action, and that one end of the locating bolt is put into the insert slot, when the disk brake enters into the insert slot to allow the lock bolt falling down into the insert slot and urges against the surface of the disk brake such that the lock body needs to be moved slightly towards the through hole on the disk brake to let the lock bolt enter into the through hole of the disk body incapacitating the disk brake. The object of quicker and more convenient disabling the disk brake is achieved. Also, it is suitable to lock the motor cycle in a limited parking space because the motor cyclist can hold the lock body in one hand without tuning the key with the other hand.

### BRIEF DESCRIPTION OF THE DRAWINGS

FIG. 1 shows a perspective view of the first preferred embodiment of the present invention;

FIG. 2 shows an exploded view of the embodiment as shown in FIG. 1;

FIG. 3 is a local sectional view of the embodiment as shown in FIG. 1;

FIG. 4 shows first assembling operation in FIG. 1;

FIG. 5 shows second assembling operation in FIG. 1;

FIG. 6 shows third assembling operation in FIG. 1;

FIG. 7 shows a perspective view of the second preferred embodiment of the present invention;

FIG. 8 shows an exploded view of the embodiment as shown in FIG. 7;

FIG. 9 is a local sectional view of the embodiment as shown in FIG. 7;

FIG. 10 shows first assembling operation in FIG. 7;

FIG. 11 shows second assembling operation in FIG. 7; and

FIG. 12 shows third assembling operation in FIG. 7.

### DETAILED DESCRIPTION OF THE INVERNTION

Hereinafter, a further detailed description of the present invention will be given with reference the accompanying drawings and preferred embodiments.

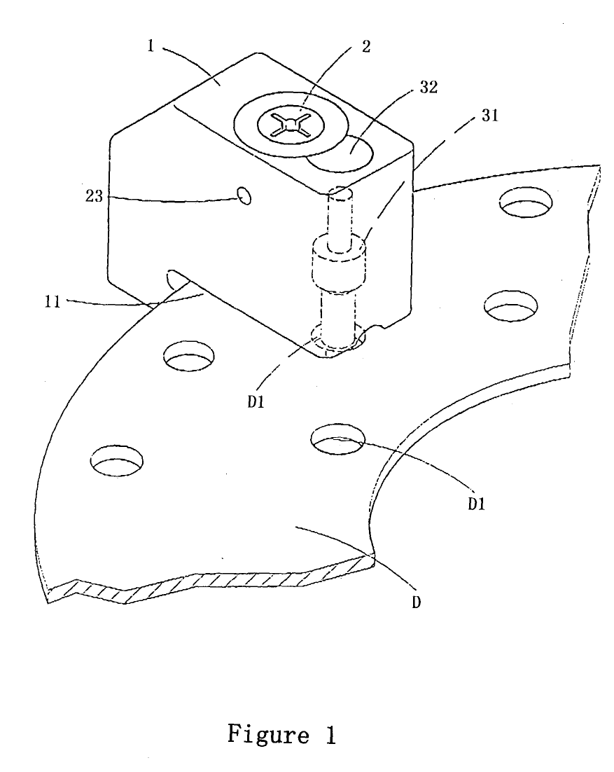

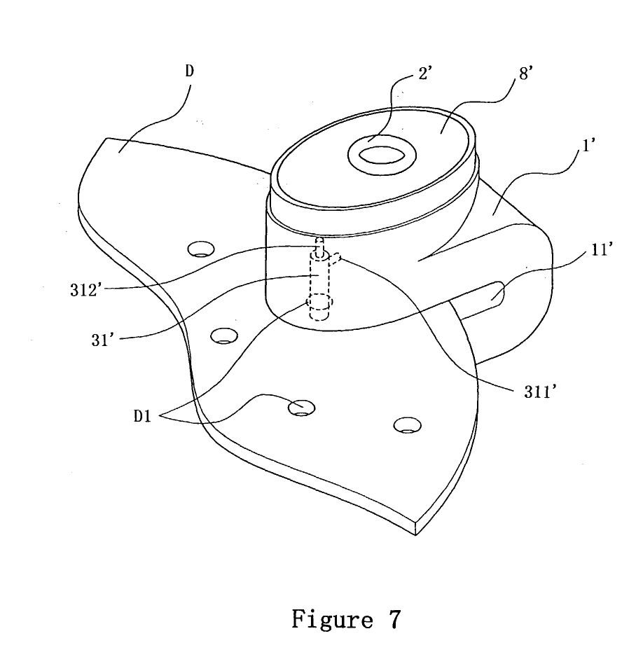

Referring to FIGS. 1 and 7, the basic structure of a locking device according to the present invention comprises a lock body 1, the main body for assembling of the lock, which comprises an insert slot 11 for receiving a disk brake D, a lock bolt 31 and a lock sleeve 2 able to be turned around by inserting a key to control the behavior of the lock bolt 31 upon passing the lock bolt 31 through a through hole D1 of the disk brake D. The lock body 1 is bolted in the disk brake D to incapacitate the disk brake.

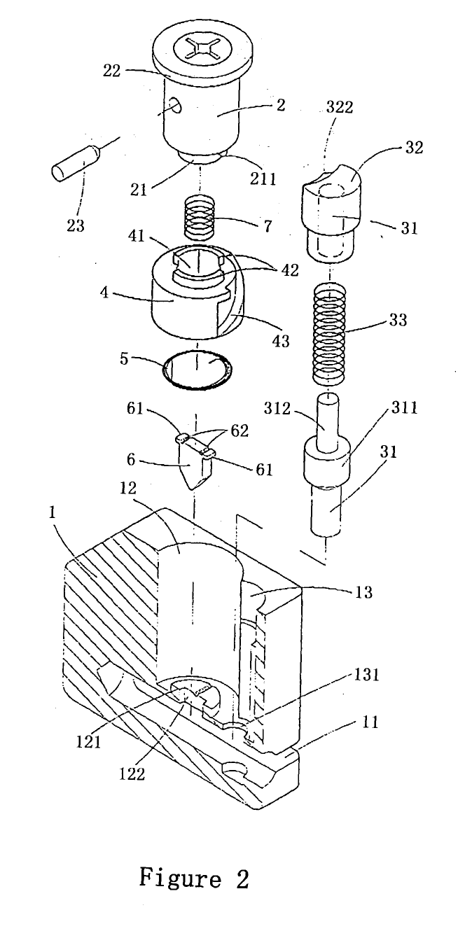

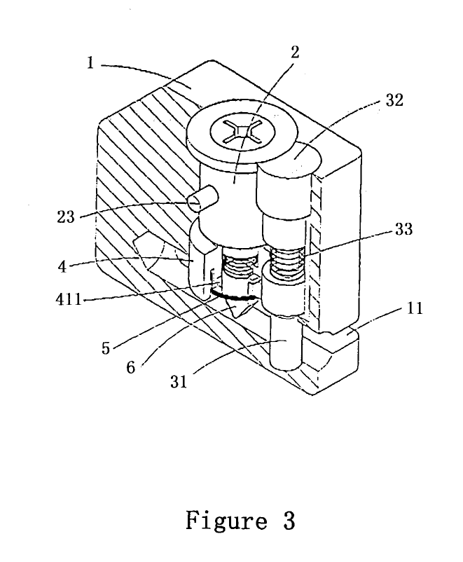

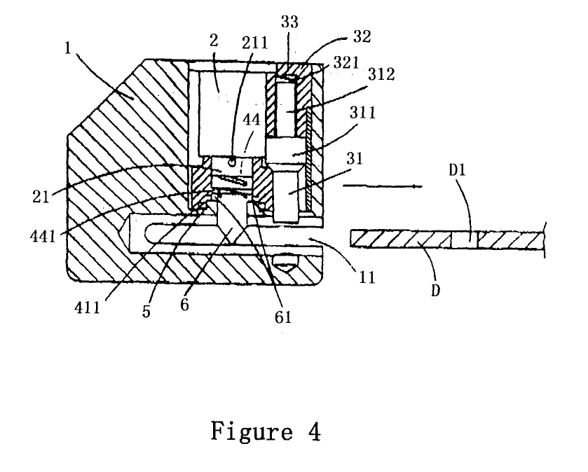

FIGS. 1 to 3 show the first embodiment of the present invention. Two intercepted parallel columned holes 12 and 13 are formed above said insert slot 11 in the lock body for housing the lock sleeve 2 and lock bolt 31 respectively, and a rotatable body 4 is engaged on the lower end of the lock sleeve 2 to bring interaction to the lock sleeve 2 and lock bolt 31. As shown in FIG. 4, a through hole 41 is centered in the rotatable body 4 and a tubing hole 411 is formed at the bottom of said through hole 41. In the columned hole 12 of the lock body 1 a protruded seat 121 is formed at the bottom thereof, allowing the rotatable body 4 to be positioned on the seat 121 through the tubing hole 411 and the lock sleeve 2 is engaged in the through hole 41 by the end of a lock core 21 directly, and a pair of ears 41 are formed on the top surface of said rotatable body 4, with a pole 211 provided laterally on the lock core 21 for operatively poking the ears 41. The lock bolt 31, structured as a shaft, of which one end is covered by an end cap 32, is housed within the columned hole 13 and contacts the insert slot 11 through a guiding hole 131 situated on the bottom of the columned hole 13, and a guiding pole 312 formed on the top of the lock bolt 31 can be inserted directly into a guiding hole 321 on the bottom of the end cap 32 (as shown in FIG. 4). Also a compression spring 33 is engaged on the guiding pole 312 of the lock bolt 31 to urge against the lock bolt 31 so that the lock bolt 31 is applied with a force to insert the lock bolt 31 into the insert slot 11 automatically. A protruded block 311 is formed in the middle of the lock bolt 31 and a slanted guiding edge 43 is formed on the outer surface thereof to drive the rotatable body of the lock bolt 31, such that the lock bolt 31 is engaged with a slanted guiding edge 43 by means of the protruded block 311. So, when a key is inserted into the lock core 21 of the lock sleeve 2 to rotate the lock core 21, the rotatable body 4 is rotated accordingly and being pushed by the slanted edge 43 up and down, such that the lock bolt 31 can enter into and withdraw from the insert slot 11. A flange 22 is formed at the outer top edge of the lock sleeve 2, to depress the end cap of the lock bolt 31, a concave arc 322 is formed adjacent the lock sleeve 2 such that the flange 22 of the lock sleeve 2 can be claspped wherein and a depression is acted on the end cap 32 by the lock sleeve 2. Now, the lock sleeve can be fixed on the lock body 1 by a fix pin to complete the assembling of the lock sleeve 2, the lock bolt 31 and the end cap 32.

In this preferred embodiment, it is important to provide a locating bolt 6 between the rotatable body 4 and the insert slot 11 for adapting the lock sleeve 2 in controlling the rotatable body 4. Herein, the locating bolt 6 shaped as a plate having a push-poking surface formed at the bottom thereof is engaged in a guiding slot 122 which is formed on the center of the protruded seat 121 below the rotatable body 4. A pair of ears 61 are formed on both sides on the top of the locating bolt 6, on the top of the ears 61 a notch recess 62 is formed to confine a compression spring 7. Urged by the compression spring 7, an end of the locating bolt 6 is inserted in the insert slot 11, and the locating bolt 6 is prevented from falling down by a stop formed by the lateral bottom of the ears 61 on both side of the locating bolt 6. In the tubing hole 411 at the rotatable body 41, a torsional spring 5 is provided, which enables the rotatable body 4 rotating in a predetermined direction automatically to urge the lock bolt 31 into the insert slot 11. Meanwhile, an inner ring 44 is formed in the middle of the through hole 41 of the rotatable body 4, a pair of notches 441 are formed on the inner ring 44 in the direction towards the locating bolt 6, such that the ears 61 of the locating bolt 6 can be passed through the inner ring 44 or located just at the notch 441 of the inner ring 44, and so serve as a confinement preventing the rotatable body 4 from following the torsional spring 5.

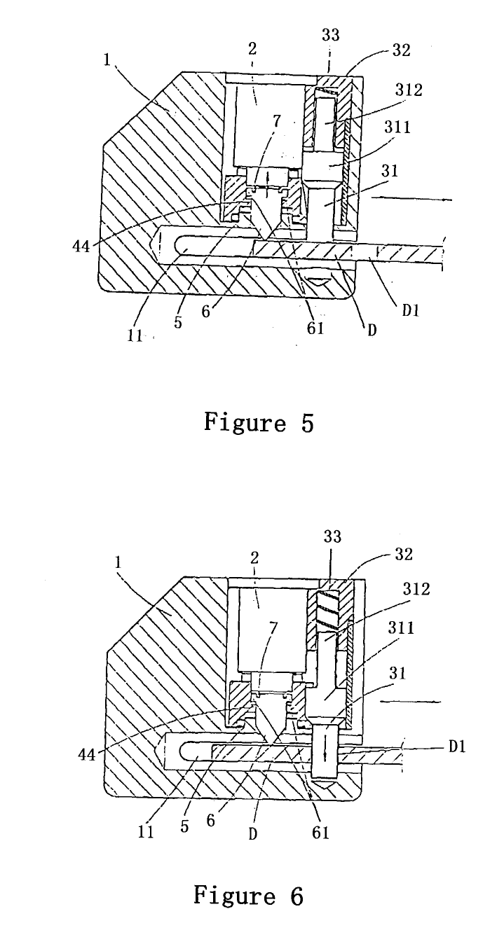

FIGS. 4 to 6 show the operation of the above-mentioned embodyment. First, as shown in FIG. 4, before bolting the lock body 1 on the disk brake D, a key is used to turn the lock core 21 of the lock sleeve 2, so that the rotatable body 4 is rotated to push the lock bolt 31 withdrawing from the insert slot 11, to enable the disk brake D to enter into the insert slot 11. At this time, in the compression sprint 5 a force biasing the rotatable body 4 in backwards direction is stored in advance by the rotation body 4, and the notch 441 of the inner ring 44 on the rotatable body 4 is turned into a situation in which it is engaged with the ears 61 of the locating bolt 6 such that a confinement can be functioned by the locating bolt 6 to prevent the rotatable body 4 from rotating. Accordingly, after the key is removed from the lock sleeve 2 the rotatable body 4 is still remained in the condition that allows the lock bolt to be withdrawn from the insert slot 11. And in the compression spring 33 on the lock bolt 31, a force urging the lock bolt 31 into the insert slot 11 is stored in advance by the elevation of the lock bolt 31. Accordingly, as shown in FIG. 5, as the brake disk D enters into the insert slot 11 on the lock body 1 and is pushed further inwards, the locating bolt 6 is poked by the brake disk D to be withdrawn inwards, at the mean time the ears 61 are separated from the notch 441 accordingly, to set the confinement on the rotatable body 4 free so the rotatable body 4 is rotated backwards by the torsional spring 5, to enable the lock bolt 31 to be inserted into the insert slot 11 by the compression spring 33 and the lock bolt 31 continues to urge against the surface of the brake disk D by means of the compression spring 33.

As shown in FIG. 6, a motor cyclist is able to quickly align the lock bolt 31 with the through hole D1 on the disk brake D by only moving slightly the lock body 1, and make the lock bolt 31 automatically enter into the through hole D1 to lock the disk brake D accordingly.

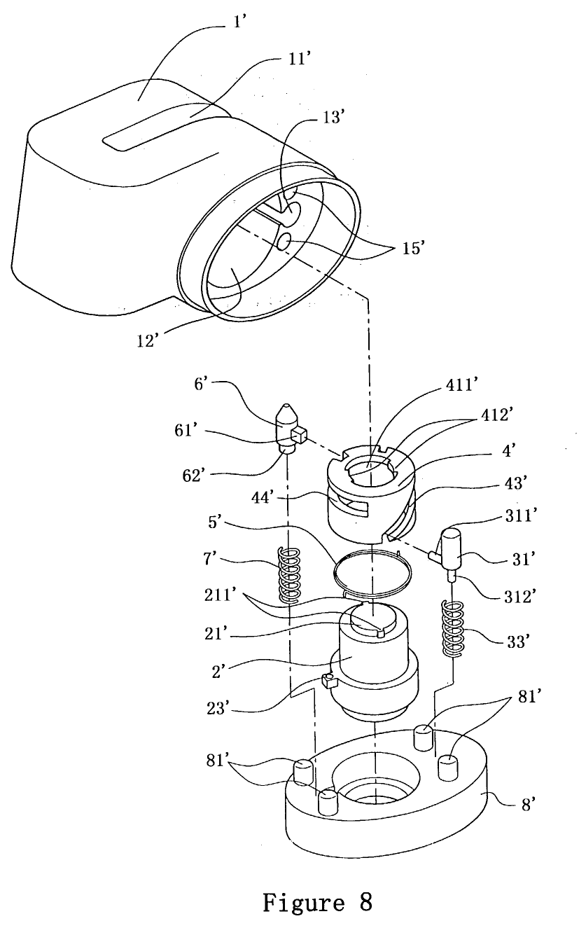

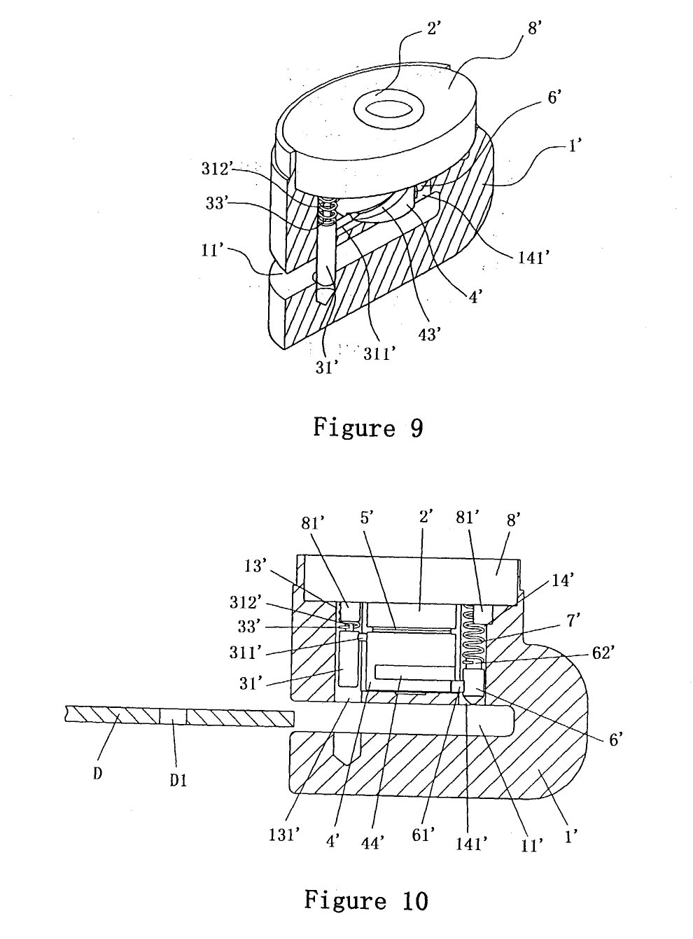

FIGS. 7 to 9 show the second preferred embodiment of the present invention. On the lock body 1′ three intercepted parallel columned holes 12′, 13′ and 14′ are formed above the insert slot 11′ in he lock body 1′ for housing the lock sleeve 2′, the lock bolt 31′ and the locating bolt 6′ respectively; four locating holes 15′ are formed on the top end surface of the lock body 1′; a top cap 8′ covers the top end surface of the lock body 1′ through an engagement between four locating bars 81′ arranged on the lower thereof and the four locating holes 15′. The lock sleeve 2′ is housed firmly in the middle columned hole 12′; on the lower end of the lock core 21′ a few protruded points 211′ are formed; at one side of the upper end of the lock sleeve 2′ an ear with small openings 23′ is formed, and the lower end of the lock sleeve 2′ houses a rotatable body 4′ for facilitating an interaction between the lock sleeve 2′ and the lock bolt 31′ or the locating bolt 6′. Refer now to FIG. 10, some small holes (not shown) are formed on the top edge of the rotatable body 4′, and a tubing hole 411′ is formed at the center of the bottom of the rotatable body 4′. A lower end of the lock core 21′ is inserted into the tubing hole 411′ formed at the bottom of the rotatable body 4′, and some protruded particles formed in the tubing hole 411′ match exactly with the protruded points 211′ on the bottom of the lock core 21′. As shown in FIG. 9, between the rotatable body 4′ and the lock sleeve 2′ a torsional spring 5′ is provided, one end of which is inserted into the opening 23′ and the other end is inserted into a small opening of the rotatable body 4′. A slanted slot 43′ and an inverted L-like guiding slot 44′ are formed in the opposite sides of the rotatable body 4′ respectively. The lock bolt 31′ and locating bolt 6′, both having a shape of shaft are housed in the left columned hole 13′ and right columned hole 14′, respectively, covered down by a top cap 8′. On each top end of the lock bolt 31′ and locating bolt 6′ an radically reduced section 312′ and 62′ is formed respectively, which, respectively engaged with a compression spring 33′ and 7′, are positioned between the lock bolt 31′, the locating bolt 6′ and the top cap 8′. Therefore, each lower end of the lock bolt 31′ and locating bolt 6′ are allowed entering into the insert slot 11′ through the guiding holes 131′ and 141′ at lower ends of the columned holes 13′ and 14′ respectively. On the lateral side of the lock bolt 31′ and locating bolt 6′, corresponding to the slanted slot 43′ and guiding slot 44′ the protruded bars 311′ and 61′ are arranged respectively. A push-poking surface is formed at the lower end of the locating bolt 6′.

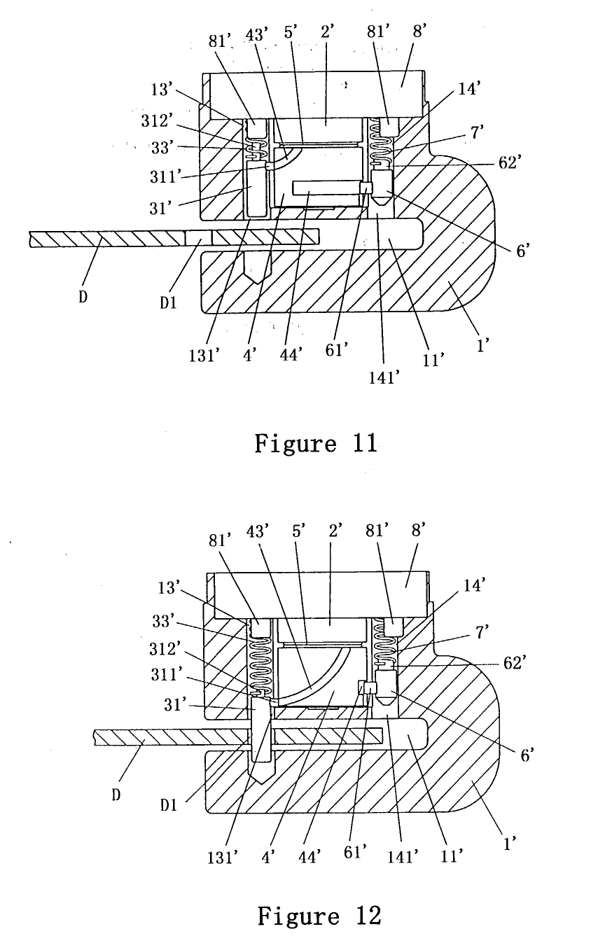

FIGS. 10 to 12 show the operation of the second preferred embodiment. First as shown in FIG. 10, before hanging the lock body 1′ on the disk brake D, first a key is used to rotate the lock core 21′ of the lock sleeve 2′, so the rotatable body 4′ is rotated. Secondly, by means of an engagement between the slanted slot 43′ and the protruded bar 311′, the lock bolt 31′ is pushed to withdraw from the insert slot 11 upwards, and the disk brake D then comes into the insert slot 11. At this time, in the twist sprint 5′ between the rotatable body 4′ and the lock sleeve 2′ a force biasing the rotatable body 4′ backwards is stored in advance due to the rotation of the rotatable body 4′, and the protruded bar 61′ of the locating bolt 6′ has just moved to the vertical section of the guiding slot 44′ passing through the horizontal section thereof and comes into engagement with the vertical section under the action of the compression spring 7′, serving as a confinement to prevent the rotatable body 4′ from rotating by means of the locating bolt 6′. Such that when the key is pulled out of the lock sleeve 2′, the rotatable body 4′ still maintains the lock bolt 31′ out of the insert slot 11′, a force urging and the lock bolt 31′ into the insert slot 11′ is stored in advance by the elevation of the lock bolt 31′. As shown in FIG. 11, as the disk brake D continually enters into the insert slot 11′ and is pushed further inwards. At the same time the protruded bar 61′ comes back from the vertical section to the horizontal section of the guiding slot 44′ of the rotatable body 4′, and stops constraining to the rotatable body 4′ accordingly. So, the rotatable body 4′ rotates backwards by the torsional spring 5′, to enable the lock bolt 31′ insert into the insert slot 11′ by the compression spring 33′ and the lock bolt 31′ continually urge against the surface of the disk brake D by means of the compression spring 33′. As shown in FIG. 12, a motor cyclist is able to quickly align the lock bolt 31′ at the through hole D1 on the disk brake D by slightly moving the lock body 1′, and make the lock bolt 31′ automatically enter into the through hole D1 to lock the disk brake D accordingly.

What is claimed is:

1. An self-guided locking device for motorcycle disk brake comprising:
a lock body, defining the main body for assembling of the lock as a whole and having an insert slot formed thereon to receive the disk brake;
a lock sleeve, provided in the lock body and controllable through a key to lock or unlock the disk brake;
a lock bolt, provided in the lock body to be forced into the insert slot formed on the lock body by an effort applied by an elastic member; and
a locating bolt, an end of which is urged against by an elastic reset member into the insert slot;
wherein upon putting the disk brake into the insert slot, the lock bolt enters into the insert slot urged by the elastic reset member, as result of that the locating bolt, poked by the disk brake, sets the lock bolt free from the confinement thereon, and the lock bolt, in turn, is urged against the disk brake, and the lock body and the lock bolt are moved to align with a through hole on the disk brake, such that the lock bolt enters into the through hole to incapacitate the motorcycle disk brake.

2. The self-guided locking device according to claim 1, wherein two intercepted parallel columned holes are formed above the insert slot on the lock body for housing the lock sleeve and the lock bolt respectively; a rotatable body is engaged on the lower end of the lock sleeve to bring interaction to the lock sleeve and lock bolt; a through hole is centered in the rotatable body and a tubing hole is formed at the bottom of said through hole; in a columned hole of the lock body a protruded seat which can be engaged with the tubing hole of the rotatable body is formed at the bottom thereof, allowing the rotatable body to be positioned on the seat through the tubing hole and the lock sleeve to be seated in the through hole by the end of a lock core; a pair of ears are formed on the top surface of said rotatable body, with a pole provided laterally on the lock core for operatively poking the ears; the lock bolt, structured as a shaft, covered by an end cap, is housed within the columned hole and contacts the insert slot through a guiding hole situated on the bottom of the columned hole; a guiding pole formed on the top of the lock bolt can be inserted directly into a guiding hole on the bottom of the end cap; a compression spring is engaged on the guiding pole of the lock bolt to urge against the lock bolt so that the lock bolt is applied with a force to insert the lock bolt into the insert slot automatically; a protruded block is formed in the middle of the lock bolt and a slanted guiding edge is formed on the outer surface thereof to drive the rotatable body of the lock bolt, such that the lock bolt is engaged with a slanted guiding edge by means of the protruded block; and a locating bolt is provided between the rotatable body and the insert slot.

3. The self-guided locking device according to claim 2, wherein said locating bolt shaped as a plate having a push-poking surface formed at the bottom thereof engages in a guiding slot which is formed on the center of the protruded seat below the rotatable body; a pair of ears are formed on both sides on the top of the locating bolt; on the top of the ears a notch recess is formed to confine a compression spring; urged by the compression spring, an end of the locating bolt is inserted in the insert slot, and the locating bolt is prevented from falling down by a stop functioned by the lateral ears on both sides of the locating bolt; in the tubing holt at the bottom of the rotatable body, a torsional spring is provided, which enables the rotatable body rotating automatically in a predetermined direction to urge the lock bolt insert into the insert slot; an inner ring is formed in the middle of a through hole of the rotatable body, a pair of notches of which ring are formed thereon in the direction towards the locating bolt, such that the ears of the locating bolt can be passed through the inner ring or located just at the notch of the inner ring, and so serve as a confinement preventing the rotatable body from following the elastic reset member.

4. The self-guided locking device according to claims 2 or 3, wherein a flange is formed at the outer top edge of the lock sleeve; an end cap to depress the lock bolt is formed adjacent the lock sleeve to form a concave arc for engaging a convex edge of the lock sleeve, such that a depression is acted on the end cap by the lock sleeve; the lock sleeve is fixed on the lock body by a fix pin to complete the assembling of the lock sleeve, the lock bolts and the end cap.

5. The self-guided locking device according to claim 1, wherein three intercepted parallel columned holes are formed above the insert slot on the lock body housed in one of the columned holes by an end cap; a lower end of the lock sleeve is provided with a rotatable body; a torsional spring is provided between the lock sleeve and the rotatable body; a slant slot and an inverted-L guiding slot are provided on the opposite side walls of the rotatable body respectively; the lock bolt and the locating bolt, both shaped as shafts, are situated in the other two columned holes on the opposite sides of the rotatable body respectively, and on the sides of the lock bolt and the locating bolt a few protruded shafts are formed which correspond to the slant slot and the guiding slot respectively; between the top ends of the lock and locating bolts and the top cap a compress spring is provided which allows to be inserted into the insert slot via a guiding hole at the bottom of the columned hole; a
